(19) United States
(12) Patent Application Publication
(10) Pub. No.: US 2024/0100470 A1
(43) Pub. Date: Mar. 28, 2024

(54) A SYSTEM FOR SEPARATING HYDROGEN FROM A FEED GAS

(71) Applicant: INDIAN INSTITUTE OF SCIENCE, Bangalore (IN)

(72) Inventors: Srinivasaiah DASAPPA, Bangalore (IN); Anand Malhar SHIVAPUJI, Bangalore (IN); Arashdeep SINGH, Bangalore (IN)

(73) Assignee: INDIAN INSTITUTE OF SCIENCE, Bangalore, KA (IN)

(21) Appl. No.: 18/264,071

(22) PCT Filed: Feb. 4, 2022
(86) PCT No.: PCT/IB2022/050976

§ 371 Date: Aug. 2, 2023

(30) Foreign Application Priority Data
Feb. 4, 2021 (IN) 202141004774

(51) Int. Cl. B01D 53/047; B01D 53/04; B01D 53/14

(52) U.S. Cl. CPC B01D 53/0476; B01D 53/0407; B01D 53/1412; B01D 53/18; B01D 2259/40007; B01D 2259/40013

(57) ABSTRACT

Present disclosure discloses a system for separating hydrogen from feed gas. The system includes at least one compressor adapted to pressurize the feed gas to predefined pressure. One or more adsorber columns are fluidly coupled to the compressor and are adapted to receive the pressurized feed gas, where the adsorber columns include a body and an adsorber bed, which is disposed within the body. The adsorber bed is configured to separate hydrogen from the feed gas. Further, the one or more adsorber columns includes a plurality of channels defined in at least one of the adsorber bed and adjacently along a length of the adsorber bed, where the channels are configured to channelize the hydrogen and regulate temperature of the adsorber bed. The configuration of the system aids in extracting pure hydrogen at low feed gas pressure.

### TECHNICAL FIELD

Present disclosure, in general, relates to extraction of hydrogen. Particularly, but not exclusively, the present disclosure relates to a system for separating pure hydrogen from a feed gas.

### BACKGROUND OF THE DISCLOSURE

Hydrogen is one of the most important and one of the most abundantly available gases which is used widely in petroleum refineries and petrochemical plants. Hydrogen is also used in semi-conductor industry, steel production, food industry, power industry and other industries for various applications. In the context of global warming and depleting fossil fuels, hydrogen is gaining attention as an alternative to the fossil fuels. Hydrogen when used in various applications, releases by-products in the form of water. Specifically, usage of pure hydrogen has well established end uses like Ammonia Synthesis and De-sulphurization. Further, hydrogen is gaining prominence as a direct fuel resource in fuel cells, both in proton exchange membrane (PEM) fuel cells as well as solid oxide (SOFC) fuel cells. These fuel cells are also blended with Methane (Methane+Hydrogen=Hythane) and used in Internal Combustion Engines. With advancements in technology, hydrogen has become a fuel of choice for fuel cell-operated systems for various automobiles and an array of different vehicles.

Conventionally, hydrogen is produced at a large scale using high-temperature reforming or partial oxidation of methane and/or hydrocarbons or through gasification of carbonaceous feedstocks. Production of hydrogen at decentralized scales, on-site is a key enabling process for continued and accelerated growth of the overall fuel cell market and the fuel cell-based vehicle market. However, there are no technically viable or cost-effective options for production of hydrogen on-site at this scale, as electrolysis of water to obtain hydrogen using an electrochemical cell is expensive. Further, durable processes such as, but not limited to, steam methane reformers that are conventionally used to obtain hydrogen, cannot be scaled down in a cost-effective manner and the routes are not green. In essence, if the fossilized route for Hydrogen production is adopted then carbon emissions shifts from dispersed (tailpipe) to centralized mode. No net carbon emission reduction is realized, a critical requirement in the current environmental scenario. Additionally, the conventional feed gasses used to extract hydrogen are stored at high pressures and feed gasses at low pressures are not an economically viable option as systems for pressurizing the feed gas to the required high pressures are costly and very complex.

Further, fueling of PEM fuel cell demands extremely high level of Hydrogen purity. For example, the PEM fuel cells require 99.97 volume percentage of pure Hydrogen for road vehicle applications. Such high Hydrogen purities are realized by gas separation units known as the Pressure/Vacuum Swing Adsorption [PSA/VSA] systems to extract pure hydrogen from a mixture of gases. The pressure/vacuum swing adsorption [PSA/VSA] system utilizes a porous adsorbent bed with specific material characteristics through which the gasses are passed to separate hydrogen from the mixture of gases. One of the drawbacks of the conventional systems is high operating pressure, which generally ranges from 10 to 35 bar at which the feed gasses have to be fed so that pure hydrogen is extracted. Due to the requirement of high pressure in the conventional systems, adoption of such systems to process feed gas which include biomass or syngas, which are at are at near ambient pressure pose a challenge in terms of additional energy expenditure, capital and equipment for gas pressurization, which are undesired.

Present disclosure is directed to overcome one or more limitations stated above or any other limitations associated with the known arts.

### SUMMARY OF THE DISCLOSURE

One or more shortcomings of the prior art are overcome by a system and a method as claimed and additional advantages are provided through the system and the method as claimed in the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a system for separating hydrogen from a feed gas is disclosed. The system includes at least one compressor adapted to receive and pressurize the feed gas to a predefined pressure. Further, the system includes one or more adsorber columns which are fluidly coupled to the at least one compressor and are adapted to receive the pressurized feed gas from the at least one compressor. The one or more adsorber columns in the system include a body and an adsorber bed, which is disposed within the body. The adsorber bed is configured to separate hydrogen from the feed gas. Furthermore, the one or more adsorber columns include a plurality of channels that are defined in at least one of the adsorber bed and adjacently along a length of the adsorber bed. The plurality of channels are configured to channelize the separated hydrogen and to regulate temperature of the adsorber bed.

In an embodiment, the predefined pressure of the feed gas is less than 4 bars.

In an embodiment, the system includes at least one second valve which is fluidly connected to the one or more adsorber columns and is configured to selectively route the separated hydrogen out of the one or more adsorber columns.

In an embodiment, the one or more adsorber columns are configured to separate hydrogen by adsorbing mixtures of the feed gas.

In an embodiment, the system includes at least one chamber that is configured to receive and enclose one or more adsorber columns.

In an embodiment, the system includes a vacuum pump which is fluidly connected to the one or more adsorber columns. The vacuum pump is configured to purge adsorbed mixtures of the feed gas from the one or more adsorber columns. Further, the system includes at least one third valve connected between the one or more adsorber columns and the vacuum pump, where the at least one third valve is configured to selectively channelize the adsorbed mixtures of the feed gas from the one or more adsorber columns to the vacuum pump.

In an embodiment, the system includes at least one pressure equalization valve which is fluidly connected between each of the one or more adsorber columns for equalizing pressure within the one or more adsorber columns.

In an embodiment, the plurality of channels are defined with varying dimensions along the length of the adsorber bed to regulate the flow rate of the pure hydrogen in the one or more adsorber columns.

In another non-limiting embodiment of the present disclosure, a method of separating hydrogen from a feed gas is disclosed. The method includes pressurizing the feed gas to a predefined pressure by at least one compressor. Further, the pressured feed gas is supplied to into one or more adsorber columns where hydrogen is separated by the one or more adsorber columns. After, separation of hydrogen from the feed gas, the hydrogen is routed out of the at least one adsorber columns.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiments when read in conjunction with the accompanying figures. One or more embodiments are now described, by way of example only, with reference to the accompanying figures wherein like reference numerals represent like elements and in which:

FIG. 1 illustrates a schematic view of a vacuum pressure swing based multi-component gas separation system, in accordance with one embodiment of the present disclosure.

FIG. 2 illustrates a process flow diagram indicating a gas separation unit, in accordance with an embodiment of the present disclosure.

FIGS. 3a-3e illustrates adsorber column configurations for active bed cooling, in accordance with an embodiment of the present disclosure.

FIG. 4a illustrates a series of graphical representations illustrating variation of adsorber exit gas composition with time at different pressures, showcasing the region of obtaining pure hydrogen, in accordance with an embodiment of the present disclosure.

FIG. 4b illustrates a series of graphical representations illustrating variation of a dimensionless gas concentration with time graphs at different adsorption pressures, in accordance with an embodiment of the present disclosure.

FIG. 4c is a bar graph illustrating a breakthrough time for non-hydrogen gaseous compounds at different adsorption pressures, in accordance with an embodiment of the present disclosure.

FIG. 4d is a bar graph illustrating variation of time of obtaining hydrogen of desired purity with adsorption pressure, in accordance with an embodiment of the present disclosure.

FIG. 5 illustrates a graph of variation of adsorber outlet gas composition with time for a practical system working under real-gas conditions, in accordance with an embodiment of the present disclosure.

FIG. 6a is a pilot scale vacuum pressure swing adsorption system, in accordance with an embodiment of the present disclosure.

FIG. 6b illustrates a gas composition vs time graph at the swing adsorption system inlet, in accordance with an embodiment of the present disclosure.

FIG. 6c is a graph illustrating temporal variation of gas composition at the exit of the system, in accordance with an embodiment of the present disclosure.

FIG. 6d is a graph illustrating temporal variation of hydrogen fraction at the exit of the system, in accordance with an embodiment of the present disclosure.

FIGS. 7a and 7b are graphs illustrating variations in adsorber bed temperature with time in systems without hydrogen re-circulation and with hydrogen re-circulation, respectively.

The figures depict embodiments of the disclosure for purposes of illustration only. One skilled in the art will readily recognize from the following description that alternative embodiments of the system and method illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that, the conception and specific embodiments disclosed may be readily utilized as a basis for modifying other devices, systems, assemblies, mechanisms and methods for carrying out the same purposes of the present disclosure. It should also be realized by those skilled in the art that, such equivalent constructions do not depart from the scope of the disclosure as set forth in the appended claims. The novel features which are believed to be characteristics of the disclosure, to its system and method, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “comprises”, “comprising”, or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

In accordance with various embodiments of the present disclosure, a system for separating hydrogen from a feed gas is disclosed. The system may include at least one compressor adapted to receive and pressurize the feed gas to a predefined pressure. Further, the system may include one or more adsorber columns which are fluidly coupled to the at least one compressor and are adapted to receive the pressurized feed gas from the at least one compressor. The one or more adsorber columns in the system may include a body and an adsorber bed, which is disposed within the body. The adsorber bed is configured to separate hydrogen from the feed gas. Furthermore, the one or more adsorber columns may include a plurality of channels that are defined in at least one of the adsorber bed and adjacently along a length of the adsorber bed. The plurality of channels are configured to channelize the separated hydrogen and to regulate temperature of the adsorber bed. This configuration of the system enables extraction of hydrogen from a feed gas which may be supplied at ambient pressure.

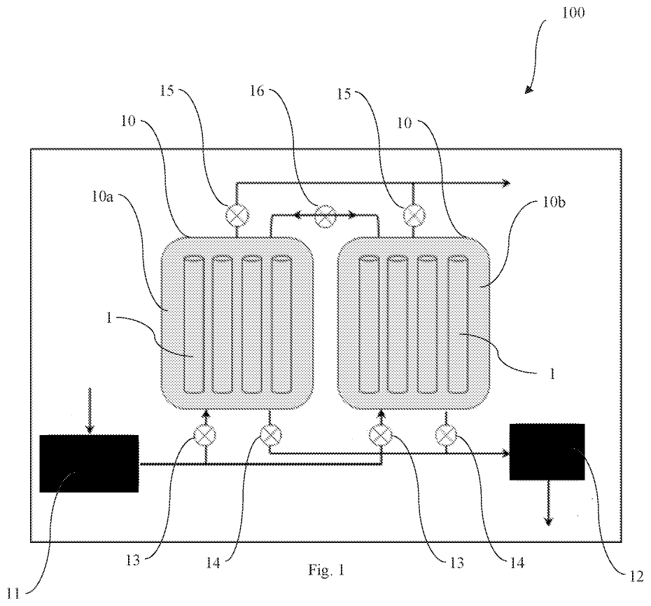

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-7b.

FIG. 1 is an exemplary embodiment of the present disclosure which illustrates a system (100) for extracting pure hydrogen (also referred to as output gas) from a mixture of gases. The system (100) may be a vacuum pressure swing-based gas separation unit (100) to separate hydrogen from a gaseous mixture or a feed gas [hereafter referred to as feed gas]. The system (100) may be configured to operate on selective adsorption of gaseous species (as single or multiple species) by one or more adsorber bed material. The bed material may possess properties including, but not limited to, least adsorption affinity, for certain species and significantly high affinity for the balance species (i.e. high selectivity factor) under appropriate conditions of temperature and pressure. This enables separation of the feed gas on passing through the adsorber bed material under corresponding pressure/temperature and mass flow rate. In an embodiment, the system (100) may be configured to extract different types of pure gas from the feed gas or feed gas depending on the requirement of a user.

As seen in FIG. 1, the system (100) may include at least one compressor (11) which may be adapted to receive and compress/pressurize the feed gas to a predefined pressure. In an embodiment, the feed gas may be supplied to the at least one compressor (11) at an ambient pressure. The predefined pressure to which the at least one compressor (11) may pressurize the feed gas may be less than 4 bars. Further, the system may include one or more adsorber columns (1). The one or more adsorber columns (1) may be fluidly coupled to the at least one compressor (11) and adapted to receive the pressurized feed gas. Furthermore, the system (100) may include at least one first valve (13) that may be connected between the one or more adsorber columns (1) and the at least one compressor (11). The at least one first valve (13) may be configured to selectively allow the pressurized feed gas to enter the one or more adsorber columns (1).

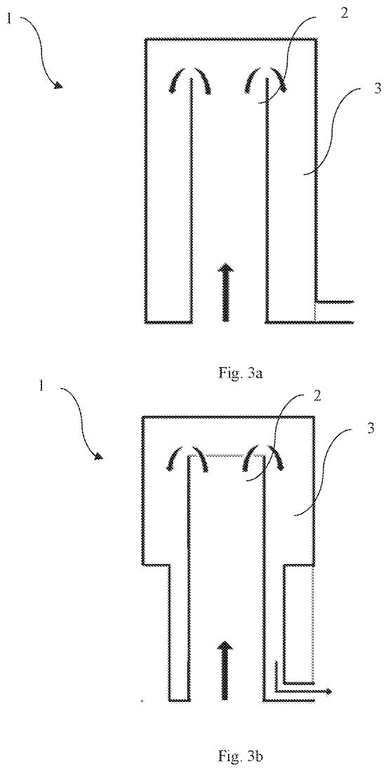

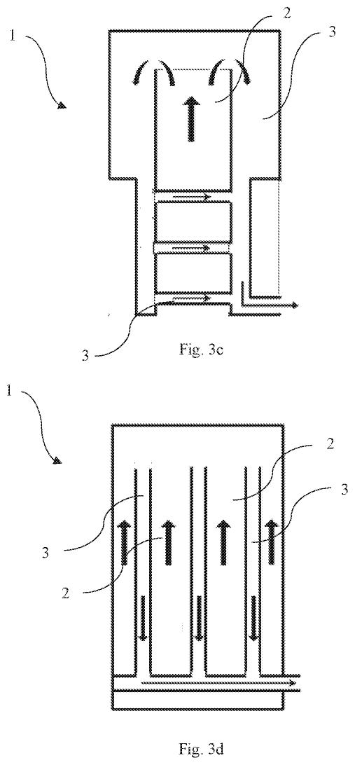

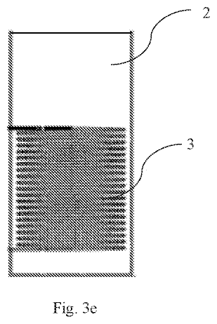

Referring now to FIG. 3a-3e, the one or more adsorber columns (1) may include a body and an adsorber bed (2) disposed within the body. The adsorber bed (2) in the one or more adsorber columns (1) may be configured to adsorb mixtures of the feed gas and allow passage of hydrogen to separate hydrogen from the feed gas. Further, the one or more adsorber columns (1) may include a plurality of channels (3) which may be defined through the adsorber bed (2) and/or defined adjacently along a length of the adsorber bed (2). The plurality of channels (3) may be configured to channelize the separated hydrogen to be extracted from the one or more adsorber columns (1) and also configured to regulate temperature of the adsorber bed (2). For example, the separated hydrogen being channelized along the adsorber bed (2) may act as a heat exchanger and may reduce the temperature of the adsorber bed (2).

In an embodiment, the plurality of channels (3) may be defined adjacently along the length of the adsorber bed (2) with constant dimensions as seen in FIGS. 3a and 3d. Further the plurality of channels (3) may be defined adjacently along the length of the adsorber bed (2) with varying dimensions as seen in FIG. 3b, which may aid in regulating the flow rate of hydrogen. Additionally, the plurality of channels (3) may be defined through the adsorber bed (2) as seen in FIG. 3c. Furthermore, the plurality of channels (3) may be defined around the adsorber bed (2) in a helical path as seen in FIG. 3e. In an illustrative embodiment as seen in FIGS. 3a-3e, the one or more adsorber columns (1) may be defined with a concentric cylinder profile, where the inner cylinder filled with the adsorbent material to form the adsorber bed (2). The feed gas may enters through a smaller diameter central cylinder, where the feed gas may be configured to rise up resulting in adsorption (and substantial heating of the adsorber bed). Further, near the top, pure cool hydrogen reverses the path passing through the outer cylinder, which forms the plurality of channels (3) and as it moves down, it also convectively carries away heat from the external surface of the adsorber bed (2). The configuration as shown in FIG. 3b is an improvisation over FIG. 3a where, a narrower channel is created near the base region of the adsorber bed (2). The narrow region enhances the velocity of hydrogen resulting in higher Reynolds number culminating in higher heat transfer. Further, the configurations as shown in FIGS. 3c and 3d are further improvisations where small diameter channels run across (normal to the axis) or parallel to the adsorber bed (2) which substantially enhance the heat transfer area and hence the heat transfer. Thus, the configurations may realize enhanced heat transfer from the adsorber bed (2) by increasing the heat transfer rate [such as cooling rate] and flow velocity either independently or in conjunction based on hydrogen generated within the system (100). The configurations as shown in FIGS. 3a-3e result in enhanced adsorption capacity (relative to the conventional column geometry) permitting much longer adsorption step. The configuration of the one or more adsorber columns (1) enable a relatively smaller quantity of bed material to be employed to extract hydrogen.

Referring back to FIG. 1, the system (100) may include at least one second valve (15). The second valve (15) may be fluidly connected to the one or more adsorber columns (1) and may be configured to selectively route the separated hydrogen out of the one or more adsorber columns (1). The at least one second valve (15) is operated to open condition for discharging of the hydrogen till a breakout time is reached for concurrent adsorption of other gases and release of hydrogen. Additionally, the system (100) may include a vacuum pump (12) which may be fluidly connected to the one or more adsorber columns (1). The vacuum pump (12) may be configured to purge the adsorbed mixtures of the feed gas from the one or more adsorber columns (1). The purging of the one or more adsorber columns (1) clears the unwanted materials from the adsorber bed (2) which may lead to blockage of the adsorber bed (2) and reduce the separation efficiency of the one or more adsorber columns (1). The purging clears the one or more adsorber columns (1) so that the feed gas received in a corresponding cycle may be effectively adsorbed. Furthermore, the system (100) may include at least one third valve (14) which may be connected between the one or more adsorber columns (1) and the vacuum pump (12). The at least one third valve (14) may be configured to selectively channelize the adsorbed mixtures of the feed gas from the one or more adsorber columns (1) to the vacuum pump (12).

In the illustrative embodiment as seen in FIG. 1, the system (100) may include at least one chamber (10) which may be configured to receive and enclose the one or more adsorber columns (1). Further, as seen in FIG. 1, a first chamber (10a) and a second chamber (10b) are provisioned as the at least one chamber, where first chamber (10a) and the second chamber (10b) may include multiple adsorber columns (1) that may be concurrently connected to a common manifold about at least one of top and bottom portions of corresponding first and second chambers (10a, 10b). Furthermore, each at least one chamber (10), that is, either the first chamber (10a) or the second chamber (10b) may be configured to alternatively carry out the adsorption process. For example, during adsorption process in the first chamber (10a), the second chamber (10b) may be under desorption, in other words the purging process. The sequence may keep switching between the each of the first chamber (10a) and the second chamber (10b) to continuously extract hydrogen of the required quality. It should be noted that, the figures are for illustration only and should not be considered as a limitation, as the system (100) may include more than or less than two chambers (10) and also may work without the chamber (10).

In an embodiment, the at least one chamber (10) may be defined with multiple compartments, where the at least one chamber (10) has an opening, and each compartment has an inlet port for receiving the feed gas.

Furthermore, the system (100) may includes at least one pressure equalization valve (16) which may be fluidly connected between each of the one or more adsorber columns (1) regulates pressure or equalize pressure within the one or more adsorber columns (1). In an embodiment, after purging of the one or more adsorber columns (1) the at least one pressure equalization valve (16) may be actuated such that the pressure within the one or more adsorber columns (1) may be equalized based on the pressure within the adjacent adsorber column. The pressure equalization enables the one or more adsorber columns (1) to be pressurized to a required limit without any external pressurization source. In an embodiment, the at least one pressure equalization valve (16) may be connected between at least two chambers so that the pressure within each of the at least two chambers may be equalized. Further, the at least one pressure equalization valve (16) may also be configured to flush the low pressure adsorber column with pure hydrogen.

In an embodiment, the pressure equalization may be performed by actuating the at least one first valve (13) or the at least one second valve (15), where simultaneous operation of either the at least one first valve (13) or the at least one second valve (15) associated with the one or more adsorber columns (1) or the at least one chambers (10) channelizes pressure between the one or more adsorber columns (1) and equalizes the overall pressure.

In an embodiment, the at least one first valve (13), the at least one second valve (15), the at least one third valve (14) and the at least one pressure equalization valve (16) may be one of but not limited to electric valve, solenoid valve, hydraulic valve and pneumatic valve.

In an embodiment, the one or more adsorber columns, the at least one first valve (13), the at least one second valve (15), the at least one third valve (14), the at least one pressure equalization valve (16), the at least one compressor (11) and the at least one vacuum pump (12) may be connected to each other through connecting lines, which may be including but not limited to pipes, hoses, conduits and the like.

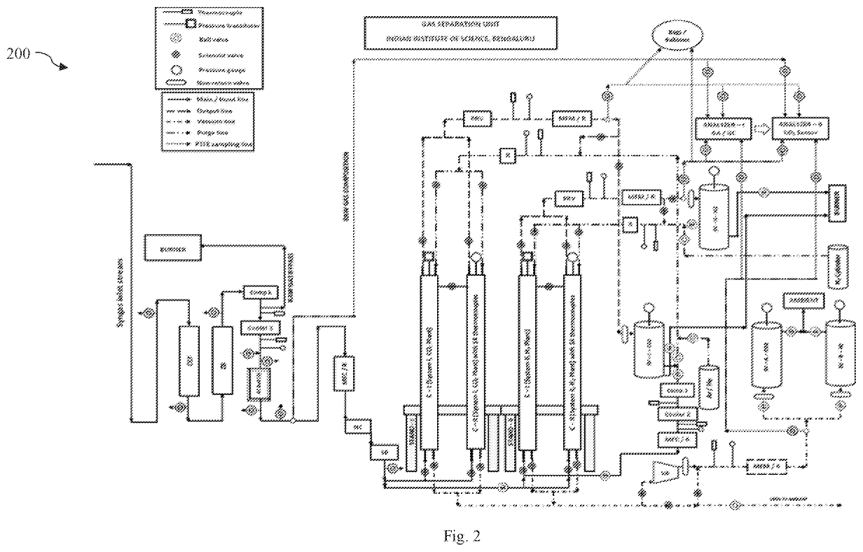

Now referring to FIG. 2 which illustrates a process flow diagram of a gas separation unit (200) that consists of the system (100). The gas separation unit (200) also consists of a plurality of pressure transducers and pressure gauges to measure the pressure of the gases, plurality of ball valves, plurality of solenoid valves, and plurality of non-return valves that allows the gases to flow in one direction to regulate the feed gas or fed gas and the hydrogen in the gas separation unit (200). The feed gas or hydrogen or purge gas in the gas separation unit (200) may be channelized through at least one of a main/input line, an output line, a vacuum line, a purge line and a sampling line. Further, the gas separation unit (200) may include a primary compressor for compressing the feed gas to a desired pressure. After passing through the primary compressor the feed gas may be passed through a cooler to reduce temperature of the feed gas, which may have increased due to compression by the primary compressor. Additionally, the gas separation unit (200) also includes an activated carbon bed (AC) through which the feed gas is passed through after the cooler such that any traces of tar compounds in the feed gas gets filtered out.

Further, the gas separation unit (200) may include a mass flow controller (MFC) and a rotameter (R) to control the feed flow rate and to measure the gas flow rate, of the feed gas collected after passing over the activated carbon bed (AC). Additionally, a silica bed (SB) is provisioned after the heating coil (HC) and is employed to trap moisture based on reaction of such moisture with silica therein. In an embodiment, the silica may be configured to react with moisture in the feed gas and such reaction may be visually indicated by the silica in a form including at least one of change in color and physical state, where content of moisture in the feed gas may in-turn act on degree of change in the silica. In the exemplary embodiment, the silica is configured to change in color, may be to pink color, when the moisture present in the feed gas is absorbed by the silica. The feed gas after passing through the silica bed (SB) is channelized to the one or more adsorber columns (1) of the system (100) such that, the gases in the feed gas except hydrogen is adsorbed. A pressure relief valve (PRV) is connected to the one or more adsorber columns (1) to set the desired adsorption pressure and release the gas when the pressure reaches the desired adsorption pressure. Further, a surge vessel (SV) is provisioned downstream of the pressure relief valve (PRV) to measure the outlet gas flow rate after the adsorption and to store the gas which are collected after the adsorption or desorption process respectively. The desorption process in the gas separation unit (200) is carried out by the vacuum pump (12) of the system (100). Furthermore, the gas separation unit (200) consists of a gas analyzer (GA) or a gas chromatography (GC) provisioned after the mass flow meter (MFM) to measure the composition of the gas which is released by the pressure relief valve (PRV). In an embodiment, the gas separation unit (200) may include a secondary compressor and a secondary cooler to compress and cool the output gas (hydrogen) exiting one of the one or more of the adsorber columns (1) before entering the other adsorber column (1) for continued operation.

In an embodiment, after the feed gas passes through the powder coated filter (PCF) provisioned at the inlet portion of the gas separation unit (200), the feed gas may be channelized to a sampling pump (SP) where a portion of the feed gas is measured to detect composition and contaminants in a gas analyzer. In an embodiment, the gas separation unit (200) may consist of one or more tanks which are adapted to collect and store the output feed gas exiting each of the one or more adsorber columns (1).

In an embodiment, steps involved in obtaining pure output gas (hydrogen) from the feed gas by the system (100) may include pressurizing the feed gas to the predefined pressure by the at least one compressor (11). Further, the method may include another pressurization step where the first valve (13) is opened and pressurized feed gas from the compressor (11) is channelized into one of the one or more adsorber columns (1). The pressure inside the adsorber column (1) is increased to the defined adsorption pressure, while the at least one second valve (15) is unoperated during increase in pressure within the adsorber column (1). After the adsorber column pressure reaches the required adsorption pressure, the discharge valve (14) is opened to route the feed gas through the adsorber bed (2) without any change in pressure, where components of the feed gas are selectively adsorbed, and the hydrogen is available at the adsorber column (1) exit. In an embodiment, the valve timings and flow to various adsorber columns are controlled by a control unit [not shown in figures]. In an embodiment, the adsorption process in the adsorber column (1) may be carried out until a breakthrough time, after which an undesired gaseous component appears in the output gas (hydrogen) that may be any other gas of the feed gas other than hydrogen. The adsorption time and thus the cycle time is dictated by the adsorbate having the least affinity in respect of the selected bed material. After the output gas (hydrogen) is collected, purging operation is activated in the adsorber column (1) which is not subjected to the adsorption step. During the purging operation, some part of the output gas (hydrogen) available at the adsorber column (1) exit during adsorption step is sent to the adsorber column (1) not subjected to the adsorption step (for example, if first chamber (10a) is in adsorption phase, the second chamber (10b) would have completed the discharge/evacuation phase). The purging of the evacuated adsorber column (1) with the output gas (hydrogen) removes any residual contaminants present and thus ensures the high purity of the desired output gas (hydrogen).

After the adsorption step, pressure in the adsorber column (1) is used to re-pressurize the purged adsorber column (1) or equalize pressure in the plurality of adsorber column (1) by the at least one pressure equalization valve (16). This way, amount of gas required for re-pressurizing the purged adsorber column (1) during feed pressurization is decreased, which in-turn reduces overall time and also compression power required for operation in the system (100). Upon equalizing the pressure in the adsorber column (1) in which adsorption has been carried out is subjected to blowdown. During blowdown, the adsorber column (1) is de-pressurized to ambient pressure by opening the at least one third valve (14) which enables venting of the adsorbed gases. The adsorber column (1) is then evacuated by connecting the adsorber column (1) to the at least one vacuum pump (12), and the pressure inside the adsorber column (1) is reduced below to sub-atmospheric levels. The drop in the pressure within the adsorber column (1) desorbs any gases adsorbed within the said adsorber column (1). After, the evacuation process, the cycle is repeated to obtain pure hydrogen from the feed gas.

In an embodiment, the system (100) may include, active cooling adsorber bed (2) to prevent reduction in adsorption capacity due to the internal heating of the adsorber bed (2). The configuration of the one or more adsorber column (1) with the plurality of channels (3) may create heat transfer areas which may significantly enhances the convective heat transfer coefficient enabling substantial draining of heat. Further, the conventional industrial systems do not have the heat transfer areas and are adiabatic in nature. The system (100) with the plurality of channels (3) result in an isothermal system which is different from the conventional industrial systems which results in better adsorption.

In an embodiment, the adsorber pressure may be below 3 bar with operations possible at further lower pressures based on the cycle time and variations in the throughput. Further, the mass flux in the column may be in the range of 0.450-0.950 g/m2-s.

In an embodiment, the adsorber bed (2) length may be in the range of 2.5 m to 5 m, preferably around 5 m. Further, the system (100) works for a longer cycle time, preferably 100 s or more than 100 s. In an embodiment, the low operating pressure and high cycle time permit enhanced interaction between adsorbent and adsorbate. Furthermore, the high overall cycle time results in permissibility of adoption of slow responding valves which gives substantially high life for the valves as compared to fast cycles.

In an embodiment, the specific power consumption of the system (100) is lower than 3 kWh/kg-H2. The power consumption is estimated based on consideration that feed gas is available at ambient and compression is carried out till the desired pressure when the columns are subjected to vacuum.

In an embodiment, the output gas may be pure hydrogen gas with at least 99.97 vol % purity.

In an embodiment, the adsorber bed (2) may be made materials including but not limited to activated carbon, molecular sieve—zeolites, metal organic framework, urea formaldehyde, basic oxide or hydrotalcite material and the like, for the separation of different gases.

In an embodiment, the adsorber bed material employed for the separation of hydrogen from the feed gas may be airsiev P180™. The characteristics of the bed material is as shown in the table 1 below, however, any other material having suitable adsorption affinity may also be employed.

TABLE 1

| Property | Airsiev P180 |
|---|---|
| Particle type | Spherical beads |
| Crushing strength (N) | 40 |
| Loss on ignition (1 hour at 950° C.) (%) | 2.5 |
| Particle diameter (mm) | >1.6 (95%) |
| | >2.5 (5%) |
| Particle density (kg/m³) | 1504.7 ± 40.1 |
| BET specific surface area (m²/g) | 363.51 |
| Total pore volume (cm³/g) | 0.1807 |
| Micropore volume (cm³/g) | 0.1408 |
| Mean pore diameter (nm) | 1.9878 |
| Bed porosity | 0.38 |
| Bulk density (kg/m³) | 630 ± 30 |

In an embodiment, experiments have been conducted and the experimental results are as shown below.

### Experiment 1:

The experiments were directed at establishing design data through the mixed-gas adsorption capacity, column breakthrough dynamics and selectivity potential of the zeolite, and its ability to generate desired quality hydrogen. Parametric analysis for the separation of hydrogen of required purity from the feed gas/gaseous mixture has been conducted in a specially designed lab-scale, fixed-bed adiabatic system (L/D=4.5) at four adsorption pressure conditions of 1.6, 2.2, 2.7, and 3.2 bar-abs. Simulated syngas generated by stable oxy-steam gasification unit having fixed gas composition—H₂: 52.5, CO: 9.9, CH₄: 4.1 and CO₂: 33.6 vol % with molar and mass feed flow rate of 0.30 m³/h and 0.24 kg/h respectively with a mass flux of 8 g/m²-s were employed. The gas composition at the outlet of the adsorber column has been continuously monitored using an online multi-point calibrated Sick AG™ make gas analyzer—S715. The gas flow rate at the inlet and outlet of the adsorber column was continuously tracked using Alicat™ mass flow controller and meter, respectively. The pressure at various positions of the system was checked using Swagelok™ pressure gauges.

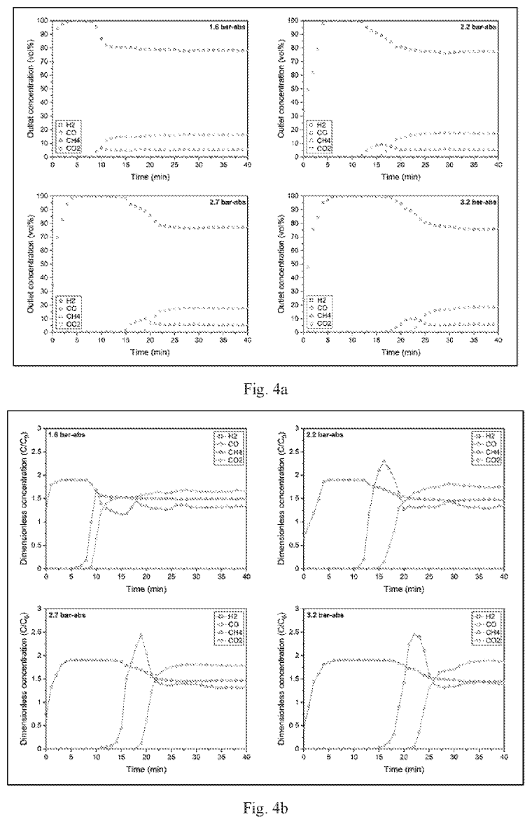

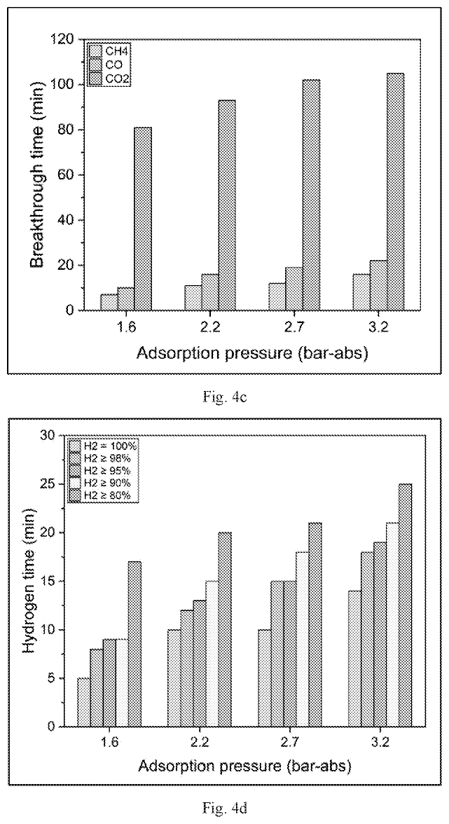

The breakthrough analysis, corresponding to the first appearance of unwanted species in the output gas (hydrogen), for the four conditions, is indicated in FIG. 4a and FIG. 4b. The FIG. 4a illustrates a typical breakthrough experiment curve in the region of interest showing the temporal variation of feed gas at the exit of the adsorber column at different pressures [at 1.6, 2.2, 2.7 and 3.2 bar-abs]. FIG. 4b presents the variation of dimensionless gas component concentration (adsorber exit specie concentration to adsorber inlet specie concentration—the inlet specie concentration remains constant) with time. It is noticed that, for a certain duration of time, no gas other than hydrogen was detected at the bed outlet. It is important to highlight that from time t=0, i.e., when the adsorber pressure attains the set pressure, typically for about initial 4 minutes while there are no other gases indicated, hydrogen is also shown to be at sub 100% levels. This is attributed to the response lag of the adopted hydrogen in a gas chromatography process to indicate hydrogen being produced. This is further corroborated as the one or more adsorber columns would have been purged with pure hydrogen in the previous cycle and with other components being adsorbed in the current cycle in the co-current flow patter, there will be no non-hydrogen components present in the exit gas. It is essential to note that the duration for which pure hydrogen evolved at the adsorber exit increases with increasing adsorber pressure. This behavior suggests that the hydrogen affinity or selectivity to other gasses increases with pressure for the current adsorbent to preferentially generate hydrogen from a multi-component feed gas containing H₂, CO, CH₄ and CO₂.

The breakthrough time which is a function of target gas partial pressure, feed flow rate and column set temperature, and taken at a dimensionless concentration of 0.05 for the non-hydrogen components in the feed syngas for different adsorber pressures is shown in FIG. 4c. The strong CO2 adsorption, being the largest non-hydrogen component in the gaseous mixture, is of particular interest. Concurrent to the breakthrough time, the time duration for which pure hydrogen is evolved from the adsorber is also consolidated as shown in FIG. 4d. On increasing the adsorber pressure from 1.6 to 3.2 bar, the pure hydrogen evolution time is increased from about 5 minutes to about 14 minutes. A similar variation in time is observed to obtain hydrogen with minimum fuel index values in the range of 98, 95, 90, and 80%.

Based on the experiments, the mixed-gas saturation adsorption capacity values of the bed material for different gases has been established and is consolidated in the table 2 below for defined input composition. The adsorption capacity for the different gases must be noted considering the potential interference from other gases that form part of the feed gas. It can be observed that CH₄ has the least affinity and is two orders of magnitude lower in terms of adsorption capacity as compared to CO₂.

TABLE 2

| | Average | | | | | | |
|---|---|---|---|---|---|---|---|
| Adsorption | feed | CH₄ adsorption | | CO adsorption | | CO₂ adsorption | |
| pressure | temperature | capacity | | capacity | | capacity | |
| (bar-abs) | (K) | (g/kg) | (mol/m³) | (g/kg) | (mol/m³) | (g/kg) | (mol/m³) |
| 1.6 | 306.4 | 1.00 | 39.45 | 3.91 | 87.98 | 135.43 | 1939.06 |
| 2.2 | 309.6 | 1.04 | 41.05 | 4.12 | 92.70 | 163.08 | 2335.07 |
| 2.7 | 308.6 | 1.13 | 44.66 | 4.25 | 95.69 | 168.97 | 2419.34 |
| 3.2 | 310.7 | 1.28 | 50.38 | 4.68 | 105.29 | 171.71 | 2458.60 |

### Experiment 2:

Based on the adsorption capacity and breakthrough dynamics, the one or more adsorber columns (1) for adsorption and desorption were designed for separating hydrogen from syngas generated from the stable oxy-steam gasification unit which is capable of handling 10 kg/h biomass feed and generates about 17 kg/h syngas with gas composition (vol %)—46.9±0.85 H₂; 13.9±0.68 CO; 3.8±0.17 CH₄; and 35.5±0.72 CO₂. A slipstream from the exit of the gasification unit is drawn through swing adsorption system (L/D=16.1) at a pressure of 3.2 bar-abs (the column pressure) which is the highest pressure corresponding to the control experiments. The molar and mass flow rates at the inlet of the adsorber columns (1) were respectively 0.78 m³/h and 0.69 kg/h with a mass flux of 24 g/m²-s.

The temporal variation of gas composition at the exit of the adsorber columns is presented in FIG. 5. Using the syngas from the oxy-steam gasification unit, it can be seen that for around 7 minutes (after the adsorption pressure is reached) no CO, CH₄ and CO₂ was detected at the bed outlet. It can further be noted in FIG. 5 that the breakthrough (C/C₀=0.05) of CO and CH₄ happens respectively at 8^{th} and 11^{th} minute. It is important to observe during this time that CO₂ was completely getting adsorbed on the material and therefore no trace of CO₂ was measured at the outlet. The CO₂ finally breakthroughs the adsorber column at 66^{th} minute. Therefore, CO, CH₄ and CO₂ concentration fronts respectively took 8, 11 and 66 minutes to reach the one or more adsorber columns outlet. The adsorber bed (2) achieves saturation (C/C₀=1) with outlet gas concertation being equal to feed gas composition at 115^{th} minute. The hydrogen recovery (on mass basis) of the system is noted to be 88.5% until the first (corresponding to CO) breakthrough point.

### Experiment 3:

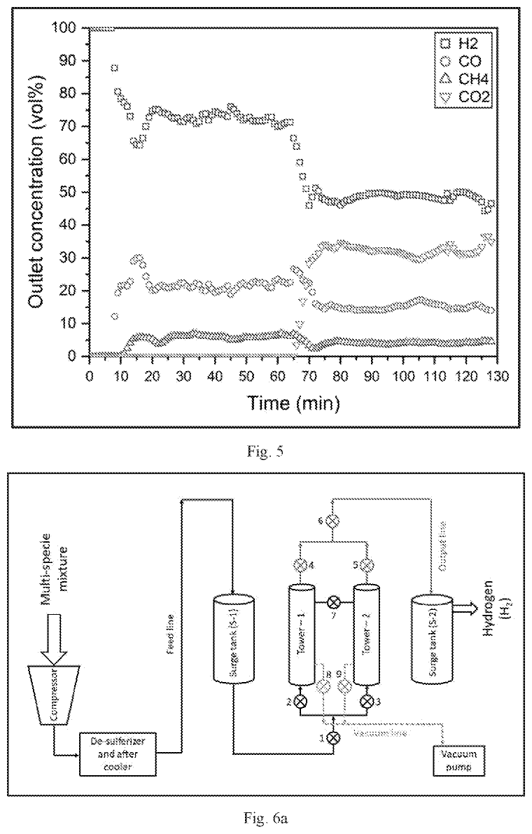

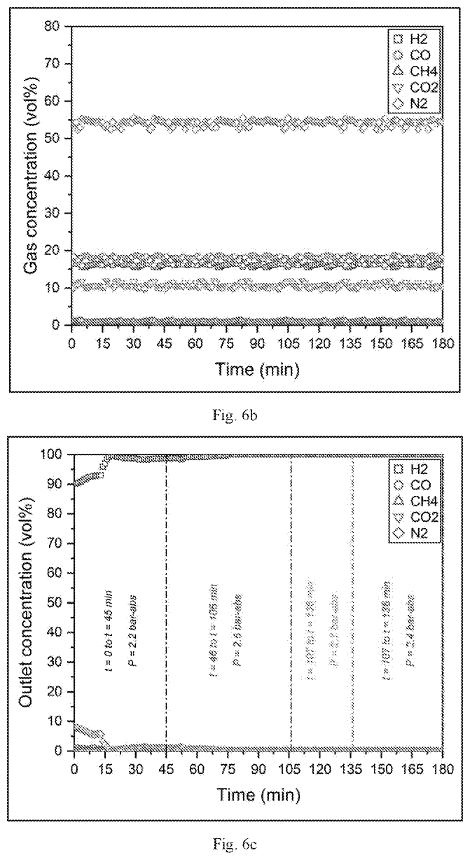

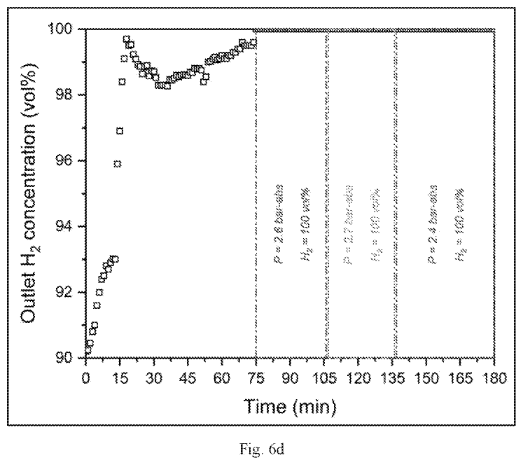

Towards addressing the scale-up and showing the effectiveness of separating hydrogen from a feed gas, including nitrogen, pilot-scale experiments were conducted. The process flow diagram of the plant scale continuous system rated for 175 kg/h of producer gas feed generated via air gasification is shown in FIG. 6a.

The system is designed to continuously generate high-purity hydrogen from the feed gas (H₂, CO, CH₄, CO₂ and N₂) by following steps of feed pressurization, adsorption, purging, pressure equalization, and desorption. For the current testing purpose, the feed gas with volume flow rate of 85 m³/h corresponding to a mass flux of 70 g/m²-s was sent through the separation system having two towers (1 and 2) for the continuous operation. The adsorber columns have an L/D ratio of 3.6 and work on a specific cycle sequence having total cycle time of 90 seconds. The flow at the inlet/outlet of the adsorber column is controlled using solenoid valves, the opening and closing times for which are controlled by a control unit. In the process cycle, producer gas [with a composition (vol %): H₂: 16.5±0.77; CO: 17.8±0.72; CH₄: 0.8±0.19; CO₂: 10.7±0.55; and N₂:54.1±0.79] from the gasification unit is compressed using a reciprocating compressor and is sent through a de-sulfurizer (for any removal of contaminants) and after-cooler (feed gas cooling) before being finally sent into an adsorber (valve number 2 and 3) for a specific time. During this step which is called as feed pressurization, the adsorber column pressure is raised to the desired adsorption pressure. Once the adsorption pressure is reached, the output valve (valve number 4 and 5) present at the top of the adsorber column is opened, and the resulting output gas (hydrogen) is sent into the surge tank where it can be stored or used for downstream applications. Two adsorber columns work simultaneously to make the system continuous. To increase the purity and recovery of the system, the purging and pressure equalization steps are performed, respectively. The purging step is performed using the slipstream of the output hydrogen getting generated using a designated purging valve (valve number 7). Whereas the pressure equalization step is performed using input valves (valve number 2 and 3) and output valves (valve number 4 and 5). The vacuum pump further ensures desorption (valve number 8 and 9) of adsorbed gases by reducing the adsorber column pressure to sub-atmospheric (0.1 bar-abs) levels. Further, the cycle sequence and step timings for a total cycle time of 90 seconds are given in the table 3 below.

TABLE 3

| | | Solenoid | | | |
|---|---|---|---|---|---|
| Solenoid | Solenoid | valve opening | | | |
| valve | valve | time (s) | | Cycle step | |
| number* | position | From | To | T-1 | T-2 |
| 1 | Inlet header | t₀ | t₁ | Feed pressurization, | ~ |
| | | | | adsorption and purging | |
| | | t₂ | t₃ | ~ | Feed pressurization, |
| | | | | | adsorption and purging |
| 2 | T-1 inlet | t₀ | t₂ | Feed pressurization, | ~ |
| | | | | adsorption and purging, | |
| | | | | pressure equalization | |
| | | t₃ | t₄ | ~ | Pressure equalization |
| 3 | T-2 inlet | t₁ | t₂ | Pressure equalization | ~ |
| | | t₂ | t₄ | ~ | Feed pressurization, |
| | | | | | adsorption and purging, |
| | | | | | pressure equalization |
| 4 | T-1 outlet | t₀ | t₂ | Feed pressurization | ~ |
| | | t₃ | t₄ | ~ | Pressure equalization |
| 5 | T-2 outlet | t₁ | t₂ | Pressure equalization | ~ |
| | | t₂ | t₄ | ~ | Feed pressurization, |
| | | | | | adsorption and purging, |
| | | | | | pressure equalization |
| 6 | Outlet | t₅ | t₁ | Adsorption | ~ |
| | header | t₆ | t₃ | ~ | Adsorption |
| 7 | Purge | t₇ | t₁ | Purging | ~ |
| | | t₈ | t₃ | ~ | Purging |
| 8 | T-1 vacuum | t₂ | t₃ | Desorption | ~ |
| 9 | T-2 vacuum | t₀ | t₁ | ~ | Desorption |

The variation of the feed (producer gas) composition at the swing adsorption system inlet is indicated in FIG. 6b. It can be observed that over the complete test duration, the gas composition broadly remains constant varying within a very narrow range.

The producer gas generated from the gasification unit is fed into the swing adsorption system, and it undergoes the adsorption-desorption process. The swing adsorption system exit gas composition is presented in FIG. 6c (scale range 0% to 100%) with FIG. 6d showing the variation of hydrogen composition (scaled range of 90% to 100%). The system is operated continuously for a total duration of 180 minutes at different adsorber column pressure conditions. The hydrogen recovery on a mass basis for the continuous operation at 2.4 bar-abs was found to be 60.2%.

It is observed that for the adsorber pressure of 2.2 bar-abs, the system exit gas has over 98% hydrogen. Subsequently once the pressure is raised to 2.6 bar-abs, hydrogen purity increases to over 99.97% with the measurement systems continuously indicating 100% hydrogen. It is important to note that operating at as low a column pressure as possible is the key feature of the current invention and towards the same, subsequent parametric analysis has been carried out. The pressure was raised from 2.6 bar-abs to 2.7 bar-abs before being reduced to 2.4 bar-abs and even at 2.4 bar-abs pressure, pure hydrogen was obtained. The hydrogen purity of the gas exiting the system was also verified using gas chromatography coupled to a thermal conductivity detector. Thus, this last set of results establish the ability of the system to operate continuously and generate pure hydrogen with low pressure.

Further, experiments have been conducted towards analyzing the impact of hydrogen recirculation which is due to the plurality of channels (3) defined within the one or more adsorber columns (1). First the values of the parameters without the hydrogen recirculation have been noted to establish a baseline. Subsequently, through the same column, keeping all the conditions same, the generated hydrogen is recirculated through the plurality of channels (3). The basic criterion used for assessing the implication of hydrogen recirculation has been the temperature of the bed material and the time for which pure hydrogen elutes from the column. It is expected that due to Hydrogen recirculation, the temperature within the bed material remains significantly lower than the base case scenario while the pure hydrogen elution time increases commensurately when all other conditions are maintained common for the baseline and hydrogen recirculation scenarios. The outcome of the investigation is presented in the form of temporal variation of temperature and concentration profile.

TABLE 4

| | |
|---|---|
| Amount of adsorbent added (kg) | 6.6 |
| Feed flow rate (syngas)- SLPM | 5 |
| Hydrogen flow rate in coil - SLPM | 2.536 |
| Working adsorption pressure (bar-g) | 2.5 |

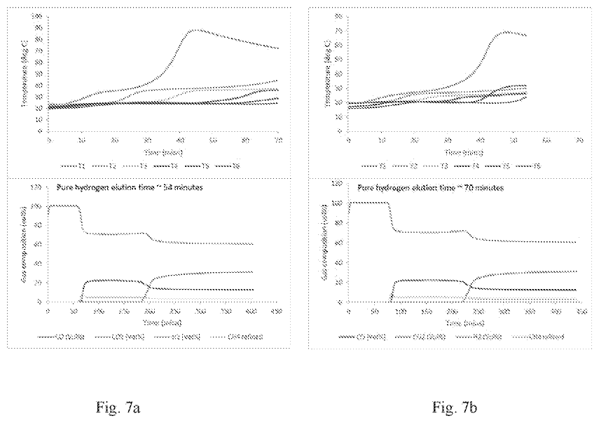

It can be observed from FIG. 7a that for the baseline scenario, the peak temperature realized in the column approaches 90 deg C. and the pure hydrogen elution time is for 54 minutes under the conditions stated in Table 1. When the hydrogen generated from the column is recirculated while maintaining the conditions as specified in Table 1, it can be observed from FIG. 7b that the peak column temperature remains restricted to 70 deg C., a drop of about 20 deg when no recirculation was carried out, and as a result, the pure Hydrogen elution time increases from 54 minutes to 70 minutes. This essentially means the same quantity of bed material could generate 40.5 Litres of additional pure hydrogen. It is important to note that controlling the flow rate of hydrogen provides an additional handle of how much heat can be extracted from the one or more adsorber columns.

With an increase in the flow rate of hydrogen in the plurality of channels, the convective heat transfer coefficient increases and thereby additional heat can be carried away from the one or more adsorber columns to bring the temperature further down and increase the adsorption capacity.

In an embodiment, the system (100) separates high purity hydrogen from a feed gas. Further, the system (100) provides pure hydrogen at low pressure which may be utilized in fuel cell applications.

In an embodiment, the system (100) is configured to operate at sub 4 bar-abs pressures and, in particular, around 3 bar-abs. In an embodiment, the system (100) generates pure hydrogen from syngas (mixture of H2, CO, CH4 and CO2) or producer gas (mixture of H2, CO, CH4, CO2 and N2).

It should be imperative that the construction and configuration of the drivetrain (100), the powertrain and any other elements or components described in the above detailed description should not be considered as a limitation with respect to the figures. Rather, variation to such structural configuration of the elements or components should be considered within the scope of the detailed description.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

Referral Numerals:

| Reference Number | Description |
|---|---|
| 100 | System |
| 1 | Adsorber column |
| 2 | Adsorber bed |
| 3 | Channel |
| 10 | Chamber |
| 11 | Compressor |
| 12 | Vacuum pump |
| 13 | First valve |
| 14 | Third valve |
| 15 | Second valve |
| 16 | Pressure equalization valve |
| 200 | Gas separation unit |
| PCF | Powder coated filter |
| ZB | Zeolites bed |
| AC | Activated carbon |
| MFC | Mass flow controller |
| R | Rotameter |
| HC | Heating coil |
| SB | Silica bed |
| PRV | Pressure relief valve |
| MFM | Mass flow meter |
| SV | Surge vessel |
| VP | Vacuum pump |
| GA | Gas analyser |
| GC | Gas chromatography |
| SP | Sampling pump |

1. A system for separating hydrogen from a feed gas, comprising:
at least one compressor adapted to receive and pressurize the feed gas to a predefined pressure; and
one or more adsorber columns fluidly coupled to the at least one compressor and adapted to receive the pressurized feed gas, wherein each of the one or more adsorber columns comprises:
a body;
an adsorber bed, disposed within the body, wherein the adsorber bed is configured to separate hydrogen from the feed gas;
a plurality of channels defined in at least one of the adsorber bed and adjacently along a length of the adsorber bed, wherein the plurality of channels are configured to channelize the separated hydrogen and to regulate temperature of the adsorber bed.

2. The system as claimed in claim 1, wherein the predefined pressure of the feed gas is less than 4 bars.

3. The system as claimed in claim 1, comprises at least one second valve fluidly connected to the one or more adsorber columns and configured to selectively route the separated hydrogen out of the one or more adsorber columns.

4. The system as claimed in claim 1, wherein the one or more adsorber columns are configured to separate hydrogen by adsorbing mixtures of the feed gas.

5. The system as claimed in claim 1, comprises at least one chamber configured to receive and enclose the one or more adsorber columns.

6. The system as claimed in claim 1, comprises a vacuum pump fluidly connected to the one or more adsorber columns, the vacuum pump is configured to purge adsorbed mixtures of the feed gas from the one or more adsorber columns.

7. The system as claimed in claim 6, comprises at least one third valve connected between the one or more adsorber columns and the vacuum pump, the at least one third valve is configured to selectively channelize the adsorbed mixtures of the feed gas from the one or more adsorber columns to the vacuum pump.

8. The system as claimed in claim 1, comprises at least one pressure equalization valve fluidly connected between each of the one or more adsorber columns for equalizing pressure within the one or more adsorber columns.

9. The system as claimed in claim 1, wherein the plurality of channels are defined with varying dimensions along the length of the adsorber bed to regulate the flow rate of the pure hydrogen in the one or more adsorber columns.

10. A method of separating hydrogen from a feed gas, the method comprising:
pressurizing, the feed gas to a predefined pressure by at least one compressor;
supplying, pressurized feed gas into one or more adsorber columns;
separating, hydrogen by the one or more adsorber columns; and
routing, the separated hydrogen out of the at least one adsorber columns.

11. The method as claimed in claim 10, wherein the predefined pressure is less than 4 bars.

12. The method as claimed in claim 10, comprises adsorbing mixtures of the feed gas by the one or more adsorber columns to separate hydrogen.
